(19) United States
(12) Patent Application Publication
(10) Pub. No.: US 2013/0084734 A1
(43) Pub. Date: Apr. 4, 2013

(54) WIRE WINDING DEVICE STRUCTURE

(71) Applicant: Chuan-Te Su, Taichung (TW)

(72) Inventor: Chuan-Te Su, Taichung (TW)

(21) Appl. No.: 13/252,181

(22) Filed: Oct. 3, 2011

(51) Int. Cl. H01R 13/72

(52) U.S. Cl. 439/501

(57) ABSTRACT

The present invention is a wire winding device structure, which provide a convenient to use multi function wire winding device, comprising: a box body, insulating disc, rotary disc, volute spring, upper cover; said rotary disc has a wire winding annular groove on its perimeter, at the bottom several metal spring piece correspondingly contacting to each metal annular tablet, at front side with swing arm and stopping post, the upper cover with inner guiding groove and outer guiding groove, wire fixing groove; through above means providing unwinding and rewinding earphone wire function, in the mean time, retaining normal signal transmission performance, achieving an effect of flexible wire length for earphone and convenient to user.

### FIELD OF THE INVENTION

The present invention is related to a wire winding device structure, which provides automatic unwinding and rewinding performance for communication wire, in the mean time, maintains normal signal transmission.

### DESCRIPTION OF THE PRIOR ART

The conventional wire winding device, owing to the necessity of retaining electric connection, can only provide a rotary disc wound with two wires of welded ends, thus not applicable to multiple wires winding. Further, the wire length must be set fixed for the applications to stop it from unwinding or rewinding. Conventional fixation is set through a stopper switch, for unwinding or rewinding manual operation is required, plus a clipper must be clipped manually to the wire for fixation, thus, not only inconvenient to operate but also the possibility of wire damaging could be incurred.

### SUMMARY OF THE INVENTION

The present invention aims at improving the above mentioned problem, to provide a wire winding device which has automatic unwinding and rewinding function and in the mean time normal signal transmission can be retained.

The main technology applied and objection are as following:

(1) providing a box body, comprising a rotary disc with wire winding annular groove, a volute spring, a upper cover for unwinding and rewinding wire out and in the box.
(2) setting a swing arm with stopping post on the rotary disk, inner and outer guiding groove, wire fixing groove in the upper cover, for permitting rotary disc being rotatable following inner and outer guiding groove with stopping post on the swing arm controlling, and through stopping post engaging wire fixing groove preventing rotary disk from rotating, thus unwinding being prevented while no pulling applied to the wire.
(3) on the bottom of rotary disc , setting metal spring piece being connected to signal transmitting line, in the box body, setting corresponding insulating disc which provided with metal annular tablet being connected to corresponding metal spring piece, for retaining signal transmission while at rotation status and for multiple line transmission, making possible for example earphone of mobile, computer can be simultaneously applied with this wire winding device.

### DETAILED DESCRIPTION OF THE PREFERRED EMBODIMENTS

With reference to FIG. 1a, 1b, 2, 3, 4, 5, 6, the wire winding device of the present device comprising:

a box body 10, insulating disc 14, rotary disc 20, volute spring 22, upper cover 30; wherein

said box body 10 has axle 11 with transverse groove 110, groove 13 and wire outlet 12 on the wall;

said insulating disc has several spaced metal annular tablet assembled in box body 10, a signal input wire 16 with plug 17, said signal input wire 16 being one end poke out through groove 13 of box body 10 and the other end electric welded to the bottom of metal annular tablet 15 of insulating disc 14;

said rotary disc 20 has axial hole 210 in the center which rotatable shrinking on the axle 11 of box body 10, a wire winding annular groove 21 on its perimeter for winding signal output wire 28, several metal spring piece 18 correspondingly contacting to each metal annular tablet 15 of insulating disc, wire 28 winding on rotary disc 20 being one end electric welded to metal spring piece 18 and the other end poke out through wire outlet 12 of box body 10, said rotary disc being one side has containing groove 211 for establishing volute spring 22, and has an engaging groove 23 on its wall, and an axle hole 24 on a place of its wall, and therein assembled a axle 250, swing arm 25 with stopping post 26, a spring 27 between swing arm 25 and rotary disc 20;

said volute spring 22, has engaging groove 23 with one end hook fixed to rotary disc 20, the other end hook fixed to transverse groove 110 of axle 11, constituting a effect of rotary 20 twist tightening volute spring 22 while unwinding output wire 28 and rotary 20 being reverse rotated by volute spring 22 while rewinding;

said upper cover 30, engaged covering box body 10 confining insulating disc 14, rotary disc 20, volute spring 22 in its position, in its inner side provided with interconnected inner guiding groove 31 and outer guiding groove 32, wire fixing groove 33, both inner and outer guiding groove 31, 32 can be poked through by stopping post 26 of swing arm 25, and the poking through action of stopping post 26 being corresponding to the rotation of rotary 20, after unwinding signal output wire for a required length and fixing position needed, stopping post 26 being set to enter wire fixing groove 33 thus forming a fixation effect, preventing rotary 20 from rotation when no manual pulling applied to the wire, leading to a effect of preventing signal output wire from unwinding and rewinding.

The function and effect of the present invention will be further described below.

With further reference to FIG. 4, the signal output wire can be connected to earphone, and signal input wire 16 connected to plug 17, and can be applied as extension lines for earphone and mic of mobile phone. As shown in FIG. 4, signal output wire 28 is in complete winded up status, while wire 28 winded in the wire winding annular groove 21, stopping post 26 of swing arm 25 of rotary disc 20 poked through outer guiding groove 32 of upper case 30, and volute spring being in a status of loose status.

When unwinding wire 28, as shown in FIG. 5, by pulling signal output wire 28, rotary disc 20 will be rotating and unwinding wire 28, while center end of volute spring 22 will be synchronized to rotate which will be the effect of twist tightening volute spring 22, and while rotary disc 20 rotating, in the mean time, its stopping post 26 of swing arm 25 will be shifting position along outer guiding groove, through wire fixing groove 33 and into inner guiding groove 31, when unwinding wire 28 stopped and released, the twisting force on volute spring 22 also released and a reverse rotation will occur, making rotary disc 20 reverse rotating an angle when stopping post 26 of swing arm 25 will be shifting to the opening of wire fixing groove 33 and entered to wire fixing groove 33, hence stuck in wire fixing groove 33, thus achieving the effect of preventing wire 28 from further unwinding.

When rewinding wire 28, as shown in FIG. 6, further pulling out wire 28 a little bit will bring stopping post 26 from wire fixing groove 33 through opening to connecting outer guiding groove 32k, corresponding to reverse rotation of volute spring 22, stopping post 26 will rotate along outer guiding groove 32 a few circle, thus bring rotary disc 20 to rotate accordingly for a few circle, that is rotary disc is rewinding wire 28. Further, a spring 27 with swing arm 25 is added to enhance the pressure on stopping post to ensure the effect of retain it in the guiding groove.

In addition, signal input wire 16 of the present invention has a plug 17, and a containing case 290, which has empty inner space and can glide freely for containing earphone pieces neatly (as shown in FIG. 2).

As described above, the wire winding device structure of the present invention provides functions of not only unwinding and rewinding wire, but also preventing wire from releasing, therefore, has effect of convenient for use and avoiding clipping damage to the wire, further, retains multiple wire signal at normal communication status, increasing the applicability, considering matching the purpose of a patent, the grant of a patent will be highly appreciated.

### BRIEF DESCRIPTION OF THE DRAWINGS

FIG. 1a is an exploded perspective view of the present invention;

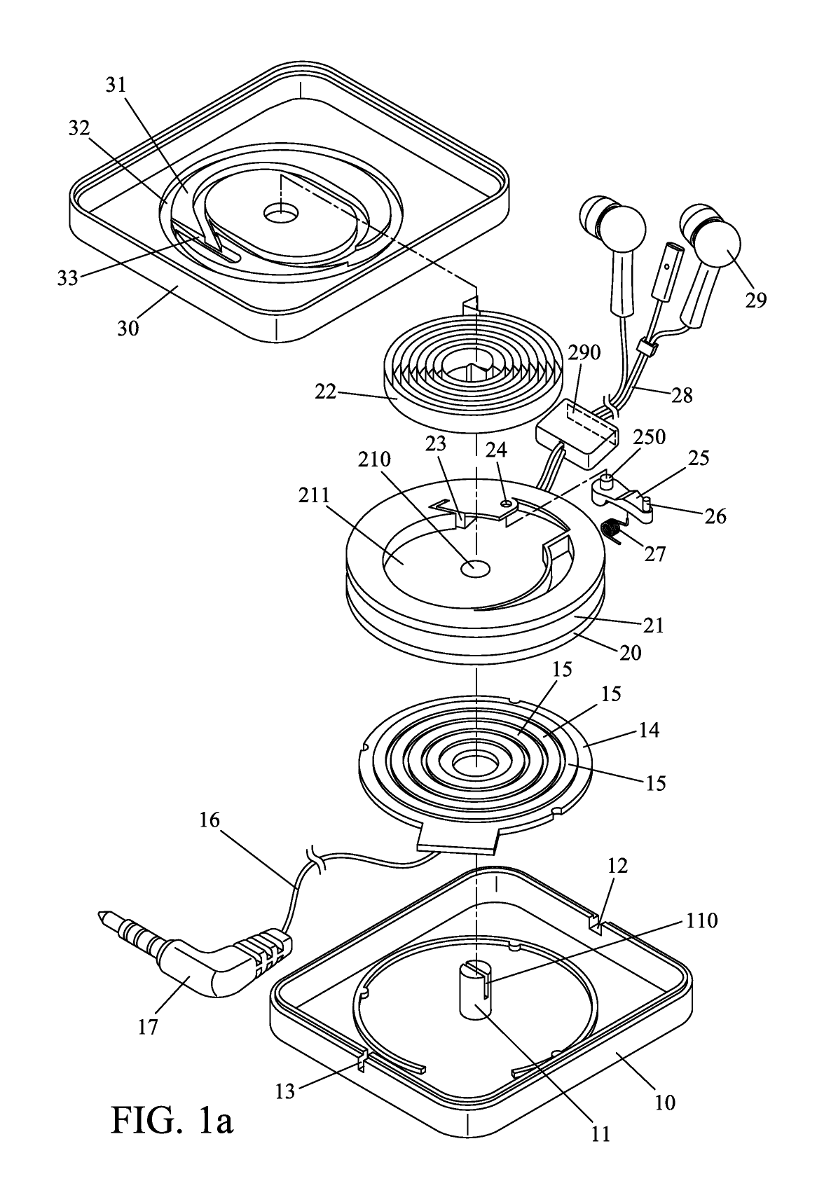

FIG. 1b is a bottom view of the turn plate of the present invention;

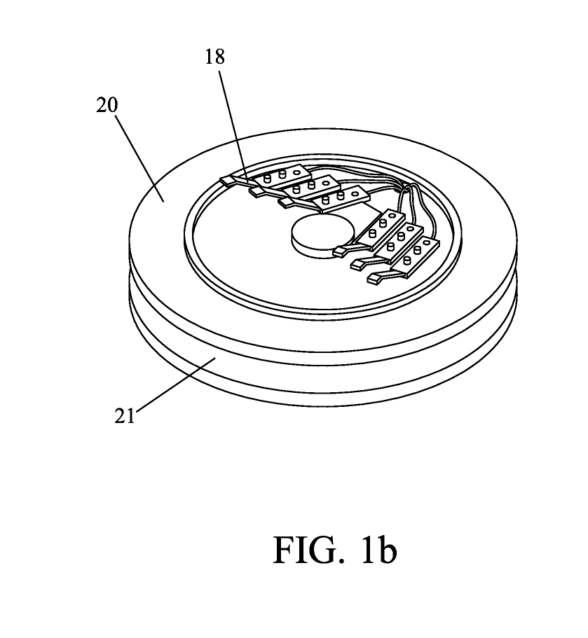

FIG. 2 is a perspective external view of the assembly of the present invention;

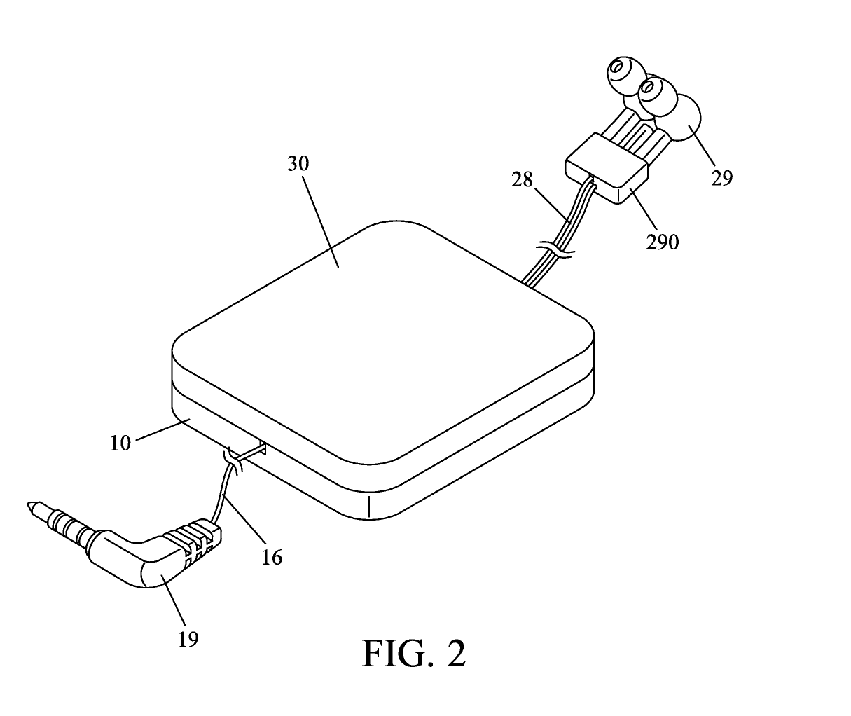

FIG. 3 is a schematic diagram of earphone separated from position fixing case;

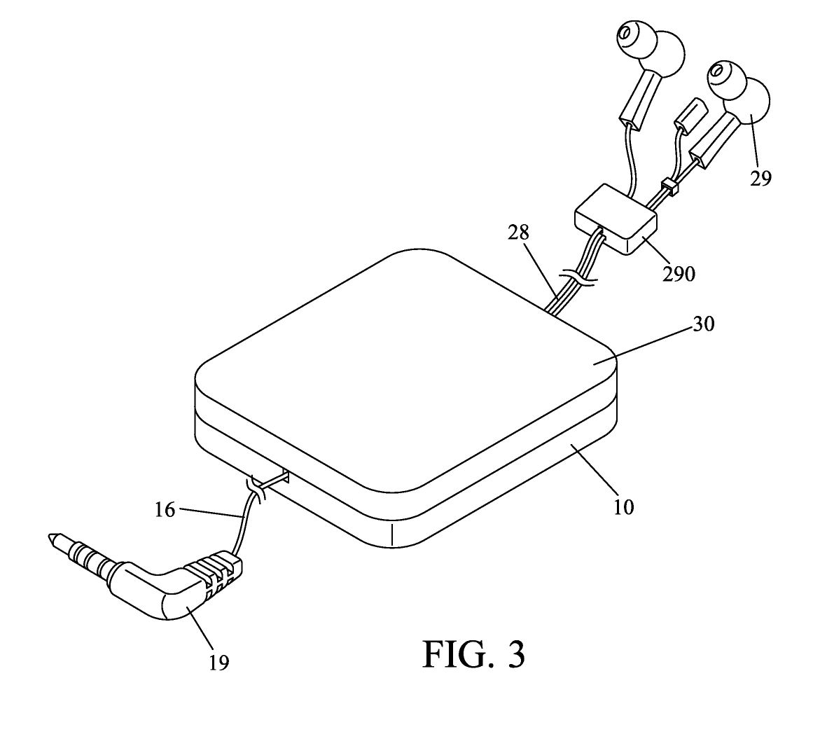

FIG. 4 is a perspective planar view of wire winded up status;

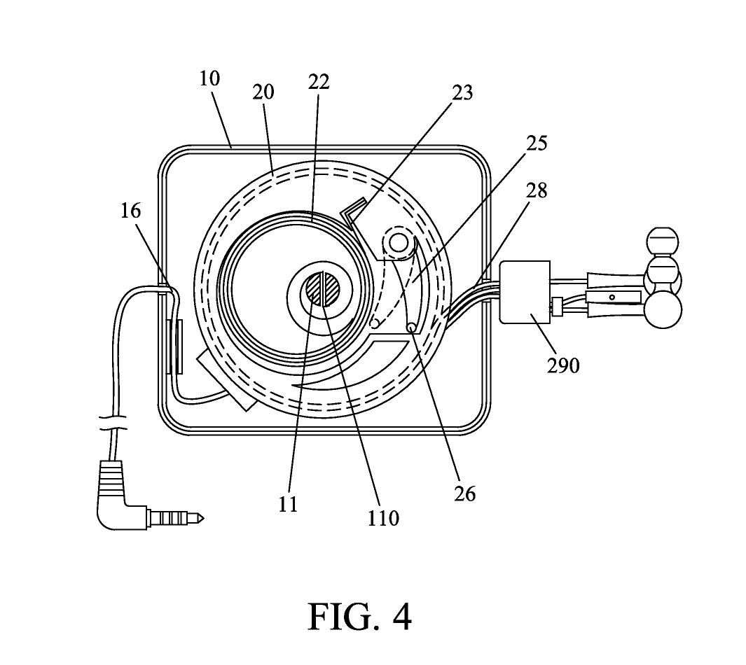

FIG. 5 is an exploded schematic diagram of wire releasing;

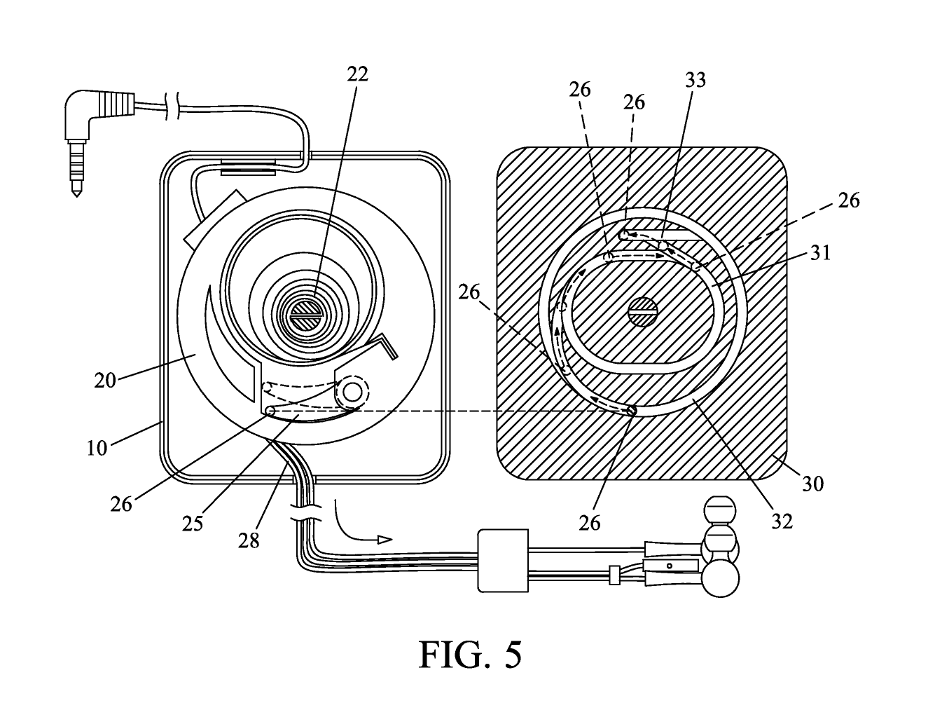

FIG. 6 is an exploded schematic diagram of wire winding.

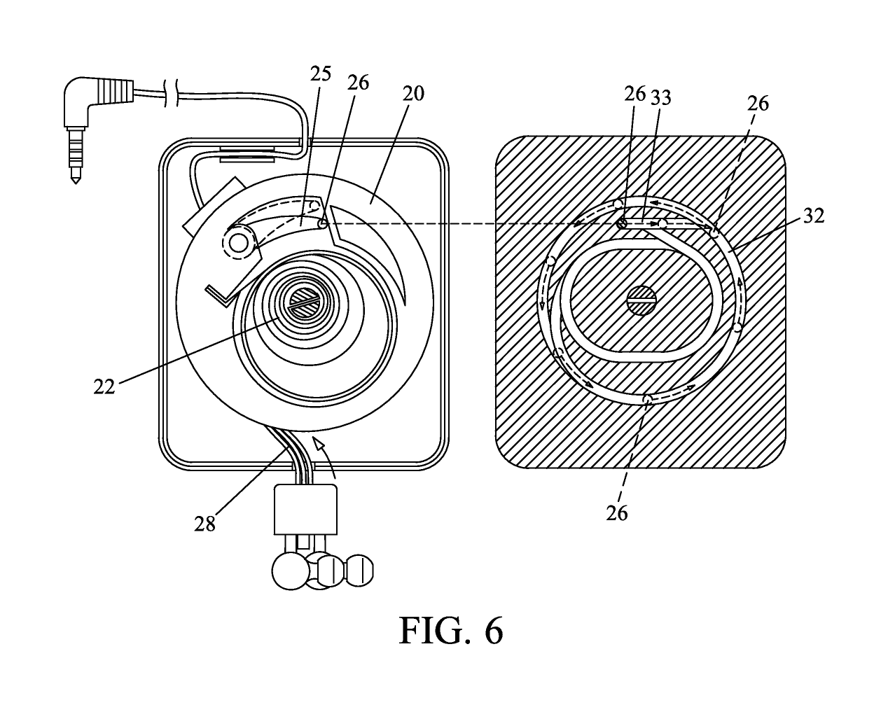

### LEGEND OF MAIN COMPONENT SYMBOLS

10 box body
11 axle
110 transverse groove
10 catching part
12 wire outlet
13 groove
14 insulating disc
15 metal annular tablet
16, 28 wire
17 plug
18 metal spring piece
20 rotary disc
21 wire winding annular groove
210 24 axial hole
22 volute spring
23 engaging groove
25 swing arm
26 stopping post
27 spring
29 earphone
30 upper cover
31 guiding groove
33 wire fixing groove
211 containing groove

What is claimed is:

1. A wire winding device structure comprising:
a box body, insulating disc, rotary disc, volute spring, upper cover; wherein said box body has an axle in the center with groove and wire outlet 12 on the wall;
said insulating disc has several spaced metal annular tablet assembled in box body, a signal input wire with plug, said signal input wire being one end poke out through groove of box body and the other end electric welded to the bottom of metal annular tablet of insulating disc;
said rotary disc has axial hole in the center which rotatable shrinking on the axle of box body, a wire winding annular groove on its perimeter for winding signal output wire, at the bottom several metal spring piece correspondingly contacting to each metal annular tablet of insulating disc, wire winding on rotary disc being one end electric welded to metal spring piece and the other end poke out through wire outlet of box body, said rotary disc being one side has containing groove for establishing volute spring, and has an engaging groove on its wall, and an axle hole on a place of its wall, and therein assembled an axle, swing arm with stopping post, a spring between swing arm and rotary disc;
said volute spring, has engaging groove with one end hook fixed to rotary disc, the other end hook fixed to transverse groove of axle, constituting a effect of rotary twist tightening volute spring while unwinding output wire and rotary being reverse rotated by volute spring while rewinding;
said upper cover, engaged covering box body confining insulating disc, rotary disc, volute spring in its position, in its inner side provided with interconnected inner guiding groove and outer guiding groove, wire fixing groove, both inner and outer guiding groove can be poked through by stopping post of swing arm, and the poking through action of stopping post being corresponding to the rotation of rotary, after unwinding signal output wire for a required length and fixing position needed, stopping post being set to enter wire fixing groove thus forming a fixation effect, preventing rotary from rotation when no manual pulling applied to the wire, leading to a effect of preventing signal output wire from unwinding and rewinding.
